(19) United States
(12) Patent Application Publication
(10) Pub. No.: US 2012/0240791 A1
(43) Pub. Date: Sep. 27, 2012

(54) BARBECUE DEVICE

(76) Inventor: Bor-Feng Wu, Taoyuan County (TW)

(21) Appl. No.: 13/071,692

(22) Filed: Mar. 25, 2011

(51) Int. Cl. A47J 37/04

(52) U.S. Cl. 99/443 R

(57) ABSTRACT

A barbecue device includes a casing, a heating unit, a water tray and a turning unit. The casing has a roasting chamber therein. The heating unit is fixed in the casing. The heating unit is located above the roasting chamber. The water tray is disposed in the casing and located below the roasting chamber. The water tray is opposite the heating unit. The turning unit is disposed in the roasting chamber of the casing. The turning unit is perpendicular to the heating heat and the water tray. The food connected to the turning unit can be rotated for roasting.

### BACKGROUND OF THE INVENTION

1. Field of the Invention

The present invention relates to a barbecue device, and more particularly to a barbecue device to roast food evenly by means of a turning unit.

2. Description of the Prior Art

A conventional grill has a barbecue net for placing food thereon. Charcoal fire is under the barbecue net to roast the food. Taiwan Utility Model No. M350327 discloses a barbecue stove structure, which comprises a stove body and a plurality of stands. The stove body comprises a slide rail in the middle of the stove body and a plurality of foot seats disposed under the slide rail. The foot seats can be bent downward. Two sides of the stove body have a plurality of engaging slots. Each of the engaging slots has a pair of lock holes at two sides thereof. The stand is made of a metal plate and has a reverse U shape. The stand has a pair of lock protrusions at two sides thereof. A positioning protrusion extends from the top of the stand. The lock protrusions are inserted in the lock holes of the engaging slot of the stove body to secure the barbecue net firmly.

The barbecue net of this barbecue stove structure is fixed, so the food on the barbecue net cannot be overturned automatically. Users have to overturn the food manually to prevent the food from being scorched. This way is laborious and the food can not be roasted evenly. Accordingly, the inventor of the present invention has devoted himself based on his many years of practical experiences to solve this problem.

### SUMMARY OF THE INVENTION

The present invention is to solve the aforesaid problem and relates to a barbecue device which comprises a casing, a heating unit, a water tray and a turning unit. The casing has a roasting chamber therein. The heating unit is fixed in the casing. The heating unit is located above the roasting chamber. The water tray is disposed in the casing and located below the roasting chamber. The water tray is opposite the heating unit. The turning unit is disposed in the roasting chamber of the casing. The turning unit is perpendicular to the heating heat and the water tray.

Preferably, the turning unit has a plurality of first holes. The turning unit comprises a plurality of rotatable members therein. Each of the rotatable members has a square second hole at a front central portion thereof. The second holes of the rotatable members are located corresponding to the first holes. The rotatable members are driven by a driving member. The driving member is driven by a motor.

Preferably, the rotatable members are belt pulleys and the driving member is a belt.

Alternatively, the rotatable members are gears and the driving member is a chain.

Alternatively, the rotatable members are worm gears and the driving member is a worm.

Preferably, the casing comprises a pair of pull doors.

Preferably, the casing comprises a pair of slide rails therein and the water tray is connected to the pair of slide rails.

Preferably, the casing comprises a pair of trays which are pivotally connected to two sides of the casing and foldable.

Preferably, the turning unit comprises a plurality of hook rings thereon.

The present invention has the following advantages.

The rotatable members of the turning unit are driven by the driving member to turn the food on the rotatable members, so that the food can be roasted evenly.

The water tray can be poured with water to collect the grease of the food, so that the barbecue device can be kept clean.

The present invention can use a barbecue net connected to the hook rings of the turning unit. The barbecue net is kept an appropriate distance with respect to the heating unit. The food to be roasted can be placed on the barbecue net and overturned manually.

### BRIEF DESCRIPTION OF THE DRAWINGS

FIG. 1 is a perspective view of a preferred embodiment of the present invention;

FIG. 2 is a front view of the preferred embodiment of the present invention;

FIG. 3 is a schematic view showing the turning unit of the preferred embodiment of the present invention;

FIG. 4 is a schematic view of the preferred embodiment of the present invention when in use;

FIG. 5 is a schematic view of the preferred embodiment of the present invention incorporated with a barbecue net;

FIG. 6 is a schematic view of another embodiment of the present invention, wherein the rotatable members are gears and the driving member is a chain; and

FIG. 7 is a schematic view of another embodiment of the present invention, wherein the rotatable members are worm gears and the driving member is a worm.

### DETAILED DESCRIPTION OF THE PREFERRED EMBODIMENTS

Embodiments of the present invention will now be described, by way of example only, with reference to the accompanying drawings.

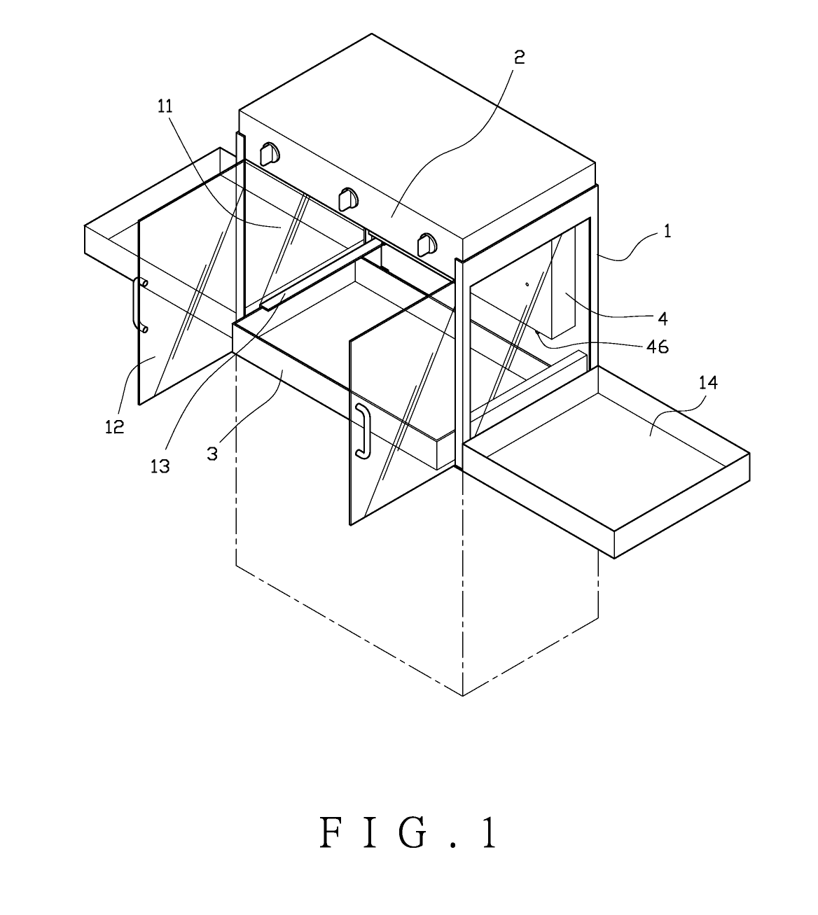

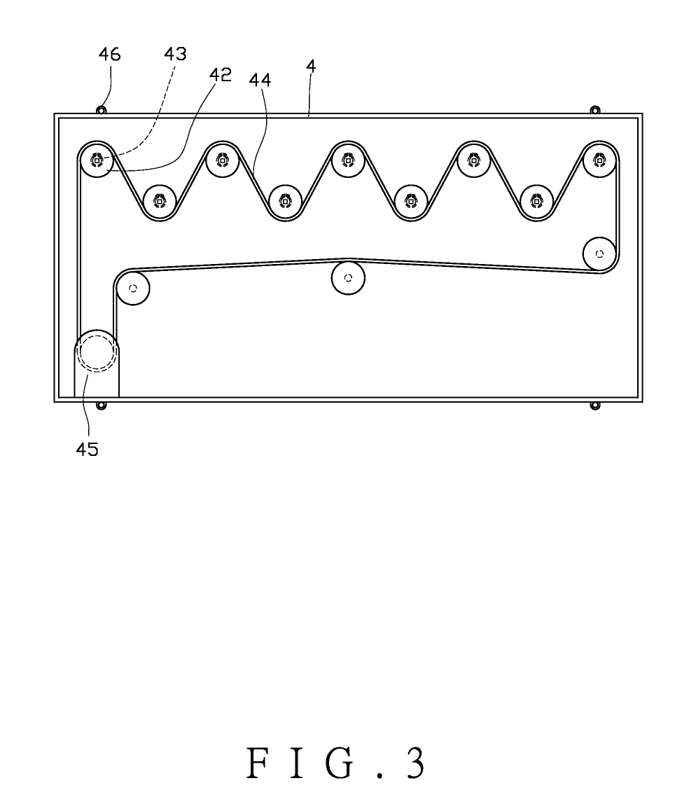

As shown in FIG. 1 and FIG. 3, the present invention comprises a casing 1, a heating unit 2, a water tray 3 and a turning unit 4.

The casing 1 has a roasting chamber 11 therein. The casing 1 comprises a pair of pull doors 12, a pair of slide rails 13 disposed in the casing 1, and a pair of trays 14 which are pivotally connected to two sides of the casing 1 and foldable.

The heating unit 2 is fixed in the casing 1. The heating unit 2 is an infrared emission member and located above the roasting chamber 11.

The water tray 3 is connected to the pair of slide rails 13 of the casing 1 and located below the roasting chamber 11. The water tray 3 can be poured with water. The water tray 3 is opposite the heating unit 2.

The turning unit 4, as shown in FIG. 3, is disposed in the roasting chamber 11 of the casing 1. The turning unit 4 is perpendicular to the heating heat 2 and the water tray 3. The turning unit 4 has a plurality of first holes 41 defined in a front side thereof. The turning unit 4 comprises a plurality of rotatable members 42 therein. The rotatable members 42 are belt pulleys. Each of the rotatable members 42 has a square second hole 43 at a front central portion thereof. The second holes 43 of the rotatable members 42 are located corresponding to the first holes 41. The rotatable members 42 are driven by a driving member 44. The driving member 44 is a belt which is driven by a motor 45. The driving member 44 drives the rotatable members 42 to turn synchronously. The top and the bottom of the turning unit 4 are respectively provided with a plurality of hook rings 46.

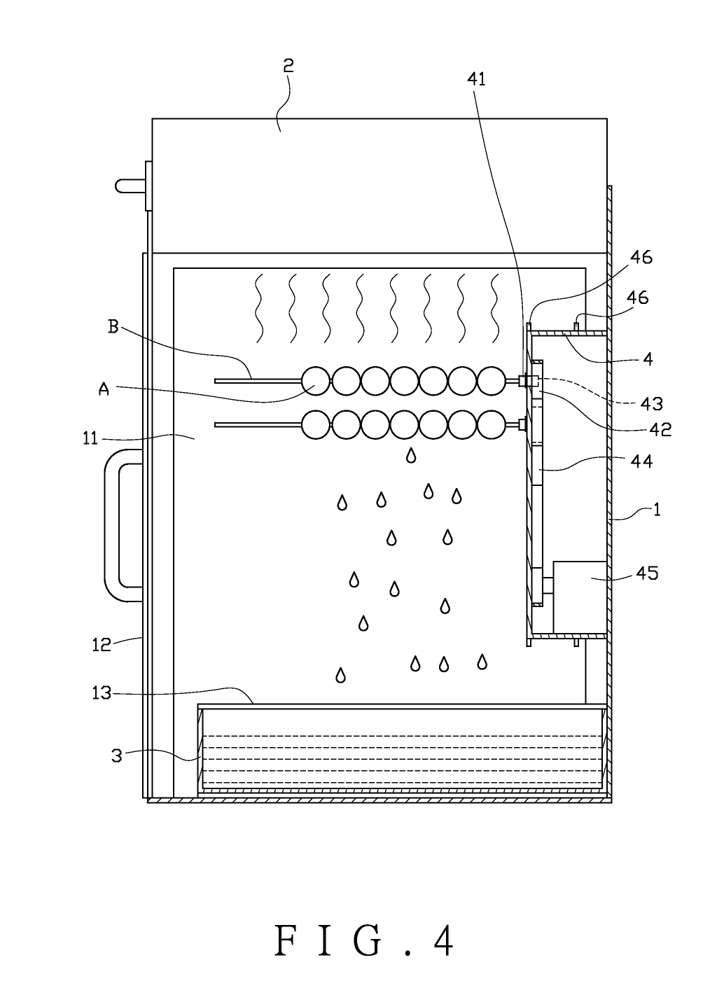

When in use, as shown in FIG. 1 and FIG. 4, a square insertion rod B inserts through food A and the insertion rod B is inserted through the first hole 41 of the turning unit 4 and positioned in the second hole 43 of the rotatable member 42.

Because the insertion rod B and the second hole 43 are square, so the insertion rod B won't rotate in the second hole 43. The heating unit 2 is started to heat the food, and then the motor 45 of the turning unit 4 is started to drive the driving member 44 to turn the rotatable members 42. The food A on the insertion rods B are turned with respect to the heating unit 2, so that the food A can be heated evenly by the heating unit 2. The grease of the food A can be collected by the water tray 3. The tray 14 at one side of the casing 1 can be used for the food to be roasted and another tray 14 at the other side of the casing 1 can be used for the cooked food.

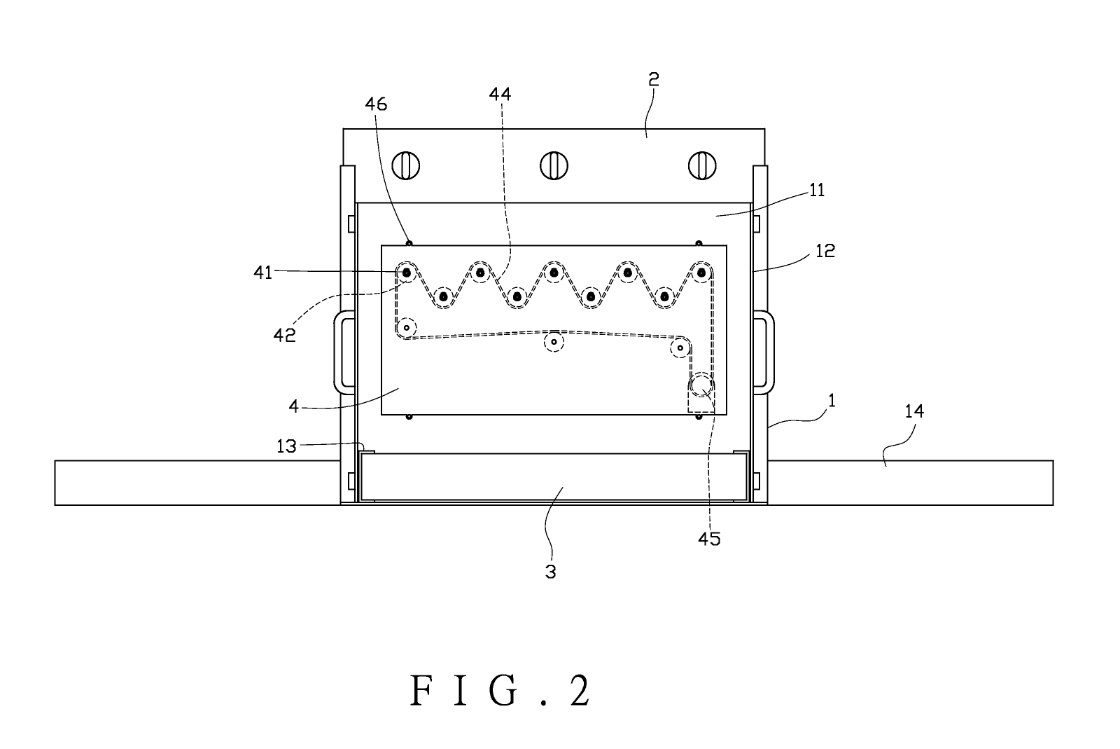

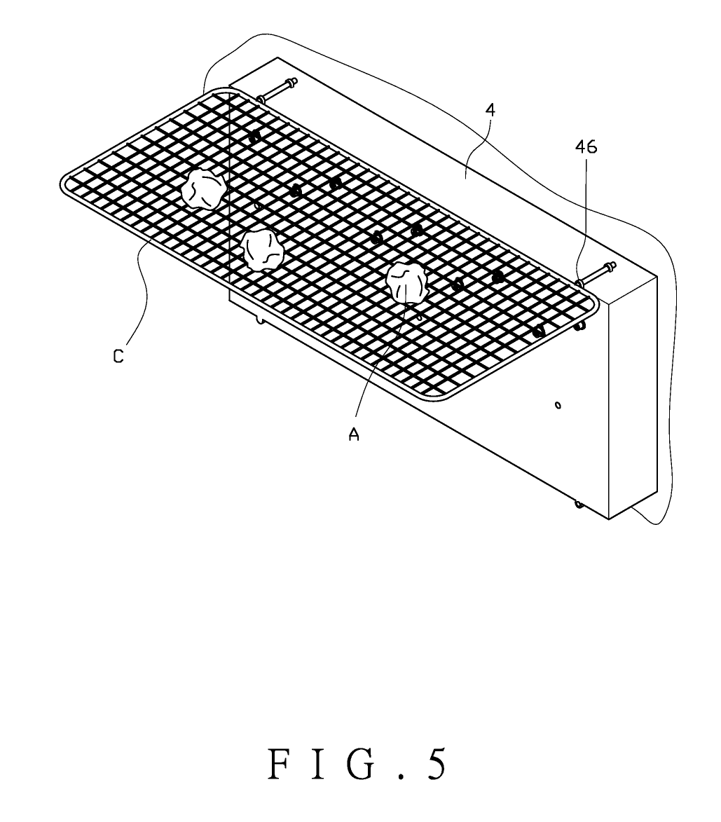

As shown in FIG. 2 and FIG. 5, a barbecue net C can be placed in the present invention. The barbecue net C is connected to the hook rings 46 at the top or the bottom of the turning unit 4 and kept a certain distance with respect to the heating unit 2. The food A can be placed on the barbecue net C to be roasted.

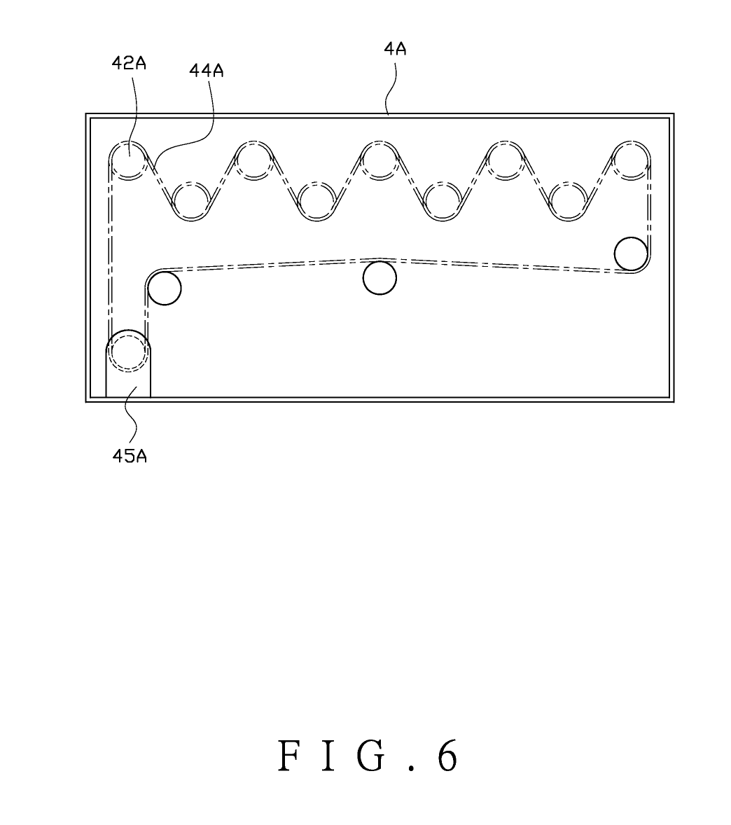

As shown in FIG. 6, the rotatable members 42A of the turning unit 4A are gears. The rotatable members 42A are driven by the driving member 44A which is a chain. The driving member 44A is driven by the motor 45A. The driving member 44A drives the rotatable members 42A to turn synchronously for the food to be roasted evenly.

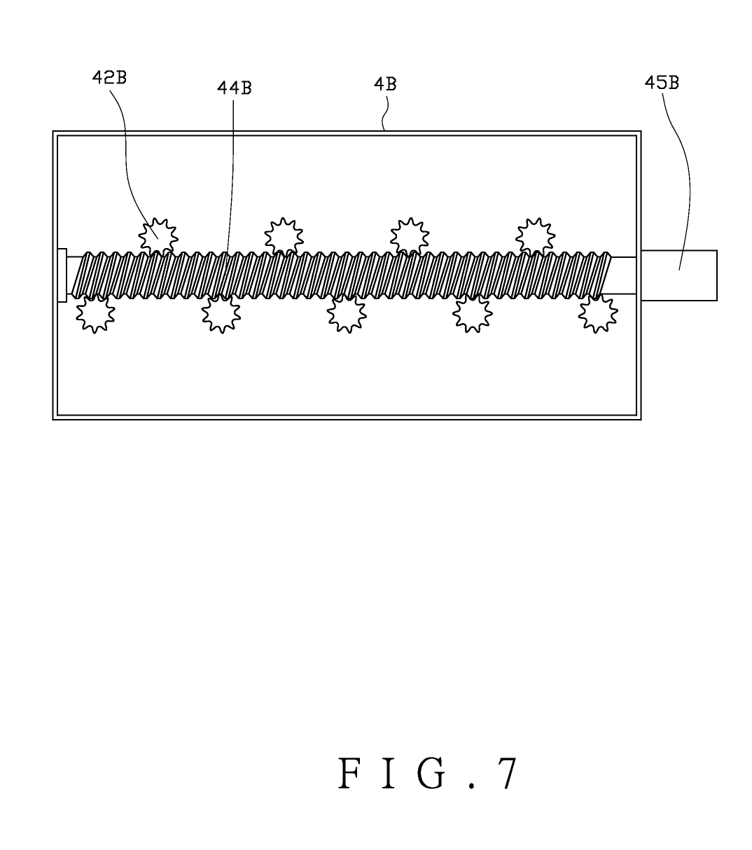

As shown in FIG. 7, the rotatable members 42B of the turning unit 4A are worm gears. The rotatable members 42B are driven by the driving member 44B which is a worm. The driving member 44B is driven by the motor 45B. The driving member 44B drives the rotatable members 42B to turn synchronously for the food to be roasted evenly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A barbecue device, comprising:
a casing having a roasting chamber therein;
a heating unit fixed in the casing, the heating unit being located above the roasting chamber;
a water tray disposed in the casing and located below the roasting chamber, the water tray being opposite the heating unit; and
a turning unit disposed in the roasting chamber of the casing, the turning unit being perpendicular to the heating heat and the water tray.

2. The barbecue device as claimed in claim 1, wherein the turning unit has a plurality of first holes, the turning unit comprising a plurality of rotatable members therein, the rotatable members each having a square second hole at a front central portion thereof, the second holes of the rotatable members being located corresponding to the first holes, the rotatable members being driven by a driving member, the driving member being driven by a motor.

3. The barbecue device as claimed in claim 2, wherein the rotatable members are belt pulleys and the driving member is a belt.

4. The barbecue device as claimed in claim 2, wherein the rotatable members are gears and the driving member is a chain.

5. The barbecue device as claimed in claim 2, wherein the rotatable members are worm gears and the driving member is a worm.

6. The barbecue device as claimed in claim 1, wherein the casing comprises a pair of pull doors.

7. The barbecue device as claimed in claim 1, wherein the casing comprises a pair of slide rails therein and the water tray is connected to the pair of slide rails.

8. The barbecue device as claimed in claim 1, wherein the casing comprises a pair of trays which are pivotally connected to two sides of the casing and foldable.

9. The barbecue device as claimed in claim 1, wherein the turning unit comprises a plurality of hook rings thereon.
